(19) United States
(12) Patent Application Publication
(10) Pub. No.: US 2004/0044775 A1
(43) Pub. Date: Mar. 4, 2004

(54) Content relay method for transmitting entry history information stored in history storage of content relay device to user terminal

(75) Inventors: Machiko Takano, Minato (JP); Yasuhiko Awamoto, Minato (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/359,566

(22) Filed: Feb. 7, 2003

(30) Foreign Application Priority Data
Aug. 27, 2002 (JP) 2002-246634

(51) Int. Cl. G06F 15/16

(52) U.S. Cl. 709/227; 709/217

(57) ABSTRACT

A content relay device obtains user identification information from a terminal. Upon relaying content information between a content providing server and the terminal, the content relay device stores history information of the content information with relating the history information to the user identification information. When content information obtained from the content providing server includes information regarding an entry field, the content relay device extracts entry history information from the stored history information according to the user identification information and information regarding the obtained content information. Then, the content relay device transmits the entry history information to the terminal.

### BACKGROUND OF THE INVENTION

1. Field of the Invention

The present invention generally relates to a content relaying technology, and more particularly, to a technology for relaying content information described in a markup language, such as an HTML, to a user terminal.

2. Description of the Related Art

Recently, portable Internet access terminals have been available. Such an Internet terminal is often connected to the Internet, with partially restricting functions of an HTML (Hyper Text Markup Language) generally provided as content information, or with using other languages. Additionally, different languages are used in such portable Internet terminals; accordingly, some contents, which can be browsed from one Internet terminal, cannot be browsed from another Internet terminal. Thus, such Internet terminals are not always user friendly.

Under these circumstances, there is a patent application filed by the applicant of the present application, which is a method in which a relay server performing a language translation is provided, and an Internet terminal is connected to a content server via the relay server.

Normally, an Internet terminal device is provided with a function of storing entry history information and browse history information called Cookie, etc. However, as in the above-mentioned method, when such an Internet terminal device is connected not directly to a content providing server but via a relay server, information translated by the relay server is browsed by the Internet terminal device. Accordingly, only the information obtained upon connecting to the relay server is left in the Cookie. Therefore, conventionally, it is impossible to make a reentry using an entry previously made upon connecting to the same content, or to obtain history information of contents actually browsed previously.

In addition, not a few portable Internet terminals are incapable of using the Cookie due to a capacity limit thereof. With such an Internet terminal, entry items or addresses even for the contents browsed previously have to be re-input each time.

### SUMMARY OF THE INVENTION

It is a general object of the present invention to provide an improved and useful content relay method, device and program in which the above-mentioned problems are eliminated.

A more specific object of the present invention is to provide a content relay method, device and program which enable a reentry using a previous browse history and a previous entry history even upon a content browsing via a relay server.

In order to achieve the above-mentioned objects, there is provided according to the present invention a content relay method in which a content relay device obtains user identification information from a terminal, and upon relaying content information between a content providing server and the terminal, stores history information of the content information in relation to the user identification information, and when content information obtained from the content providing server includes information requesting an entry of information, extracts entry history information from the stored history information according to the user identification information and information regarding the content information, and transmits the entry history information to the terminal.

According to the present invention, information previously requested by the terminal is stored in the content relay device, and according to this stored information, an operation using previous entry history is performed.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating a configuration of a content system using a content relay server according to the present invention;

FIG. 2 is a diagram illustrating a configuration of a user terminal shown in FIG. 1;

FIG. 3 is a diagram illustrating a configuration of a user portable terminal shown in FIG. 1;

FIG. 4 is a diagram illustrating a configuration of a content relay server shown in FIG. 1;

FIG. 5 is a first flowchart of a procedure for registering a user in the content relay server;

FIG. 6 is a second flowchart of the procedure starting in FIG. 5;

FIG. 7 is a diagram illustrating registration screens displayed on a display of the user portable terminal shown in FIG. 3;

FIG. 8 is a diagram illustrating a user registration table of a user DB storing user registration information;

FIG. 9 is a diagram illustrating a registration completion screen and an error screen displayed on the display of the user portable terminal shown in FIG. 3;

FIG. 10 is a first flowchart of a communication process between the user portable terminal and a content providing server via the content relay server shown in FIG. 1;

FIG. 11 is a diagram illustrating an authentication screen and an authentication permission screen displayed on the display of the user portable terminal shown in FIG. 3;

FIG. 12 is a second flowchart of the communication process starting in FIG. 10;

FIG. 13 is a diagram illustrating an authentication failure screen displayed on the display of the user portable terminal shown in FIG. 3;

FIG. 14 is a diagram used for explaining request information transmitted from the user portable terminal;

FIG. 15 is a third flowchart of the communication process starting in FIG. 10;

FIG. 16 is a fourth flowchart of the communication process starting in FIG. 10;

FIG. 17 is a diagram illustrating a folder table stored in a history folder prepared in a history DB shown in FIG. 4;

FIG. 18 is a diagram illustrating a content information screen displayed on the display of the user portable terminal shown in FIG. 3;

FIG. 19 is a diagram illustrating the content information screen including entry support marks;

FIG. 20 is a fifth flowchart of the communication process starting in FIG. 10;

FIG. 21 is a diagram illustrating the content information screen including entry candidates and a screen displaying only the entry candidates;

FIG. 22 is a diagram illustrating the content information screens including a selected entry candidate;

FIG. 23 is a sixth flowchart of the communication process starting in FIG. 10;

FIG. 24 is a diagram illustrating a screen indicating an acceptance of entered information;

FIG. 25 is a first flowchart of a content information transmission process conducted by the content relay server;

FIG. 26 is a diagram illustrating a screen displaying content information including a “content information transmit” mark and a “content information store” mark;

FIG. 27 is a diagram illustrating a screen displaying a mail noticing a transmission of content information; and

FIG. 28 is a second flowchart of the content information transmission process starting in FIG. 25.

### DETAILED DESCRIPTION OF THE PREFERRED EMBODIMENTS

A description will now be given, with reference to the drawings, of embodiments according to the present invention.

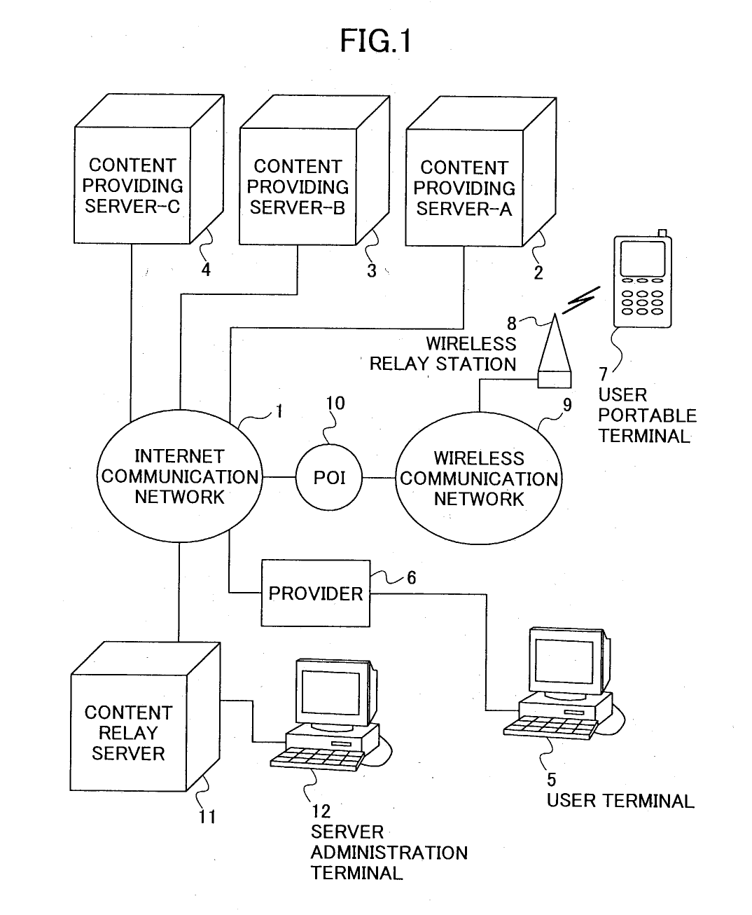

FIG. 1 is a diagram illustrating a configuration of a content system using a content relay server according to the present invention.

In FIG. 1, each of a content providing server-A 2, a content providing server-B 3 and a content providing server-C 4 provides content information via an Internet communication network 1.

A user terminal 5 used by a user is connected to a provider 6 by a telephone line or a private line, and is connected to the Internet communication network 1 via the provider 6. In the present embodiment, when the user terminal 5 communicates with a server, etc., on the Internet communication network, the user terminal 5 connects to the server via the provider 6 and the Internet communication network 1.

A wireless user portable terminal 7, such as a mobile phone provided with an Internet access function or a PDA (Personal Digital Assistant) provided with a wireless communication function, used by a user is connected to a wireless communication network 9 via a wireless relay station 8. The wireless communication network 9 is connected to the Internet communication network 1 via a POI (Point Of Interface) 10. In the present embodiment, when the user portable terminal 7 communicates with a server, etc., on the Internet communication network, the user portable terminal 7 connects to the server via the wireless relay station 8, the wireless communication network 9, the POI 10 and the Internet communication network 1.

A content relay server (a content relay device) 11 relays a communication between the content providing server 2, 3 or 4 and the user terminal 5 or the user portable terminal 7. Upon relaying, the content relay server 11 translates a content language that describes content information, and stores entry/browse history, etc.

A server administration terminal 12 is used by an administrator of the content relay server 11 to administrate the content relay server 11. In the present embodiment, the server administration terminal 12 is connected directly to the content relay server 11; however, the server administration terminal 12 may be connected to the content relay server 11 via the Internet communication network 1 or a dedicated communication line, etc.

Hereinbelow, descriptions will be given of elements composing the user terminal 5, the user portable terminal 7 and the content relay server 11 shown in FIG. 1.

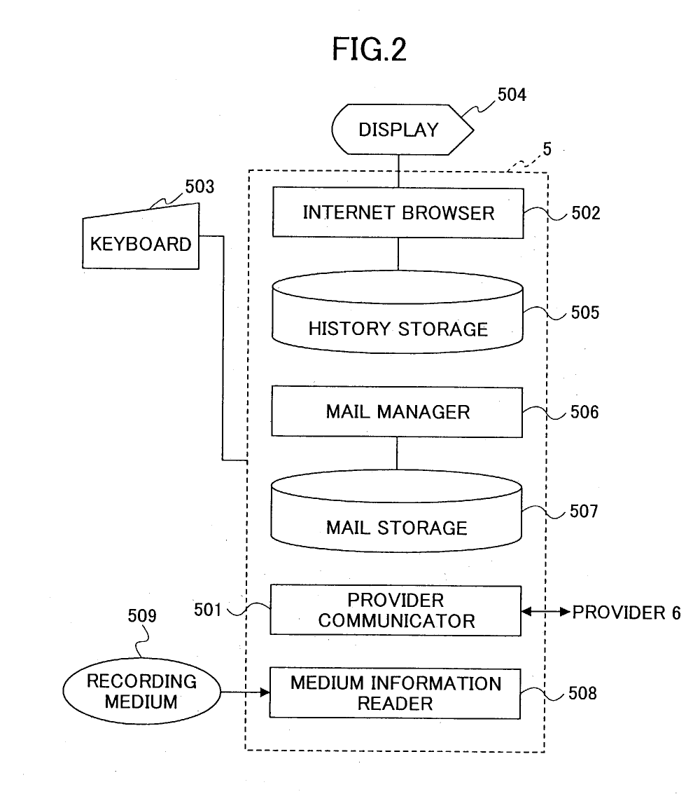

First, a description will be given, with reference to FIG. 2, of a configuration of the user terminal 5.

In FIG. 2, a provider communicator 501 performs a communication with the provider 6. An Internet browser 502 obtains content information specified by a user using a keyboard 503, etc., from one of the servers connected to the Internet communication network 1, and displays the obtained content information on a display 504. The Internet browser 502 controls the provider communicator 501 to connect to the provider 6, and as described with reference to FIG. 1, the Internet browser 502 connects to the Internet communication network 1 via the provider 6, and communicates with a targeted server connected to the Internet communication network 1 so as to obtain the specified content information. Additionally, history information gained by the Internet browser 502 is stored in a history storage 505.

A mail manager 506 controls the provider communicator 501 to connect to the provider 6, and connects to the Internet communication network 1 via the provider 6 so as to control an exchange of mail utilizing the Internet communication network 1. Additionally, information of each exchanged mail is stored in a mail storage 507.

A medium information reader 508 reads information stored in a recording medium 509, such as a CD-ROM or a DVD-ROM. The Internet browser 502 and the mail manager 506 are often provided as programs causing the user terminal 5 to perform the above-described functions of the Internet browser 502 and the mail manager 506. By the medium information reader 508 reading the programs stored in the recording medium 509, and making the programs executable in the user terminal 5 (i.e., installing the programs in the user terminal 5), the user terminal 5 can function as the Internet browser 502 and the mail manager 506.

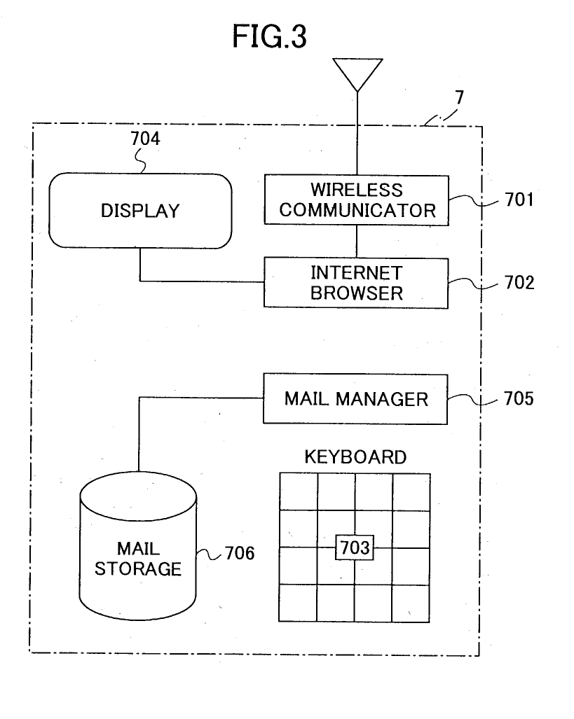

Next, a description will be given, with reference to FIG. 3, of the user portable terminal 7.

In FIG. 3, a wireless communicator 701 performs a communication with the wireless relay station 8. An Internet browser 702 obtains content information specified by a user using a keyboard 703, etc., from one of the servers connected to the Internet communication network 1, and displays the obtained content information on a display 704. The Internet browser 702 controls the wireless communicator 701 to connect to the wireless relay station 8. Thus, the Internet browser 702 connects to the Internet communication network 1 via the wireless relay station 8, the wireless communication network 9 and the POI 10, and communicates with a targeted server connected to the Internet communication network 1 so as to obtain the specified content information.

A mail manager 705 controls the wireless communicator 701 to connect to the wireless relay station 8, and connects to the Internet communication network 1 via the wireless relay station 8, the wireless communication network 9 and the POI 10 so as to control an exchange of mail utilizing the Internet communication network 1. Additionally, information of each exchanged mail is stored in a mail storage 706.

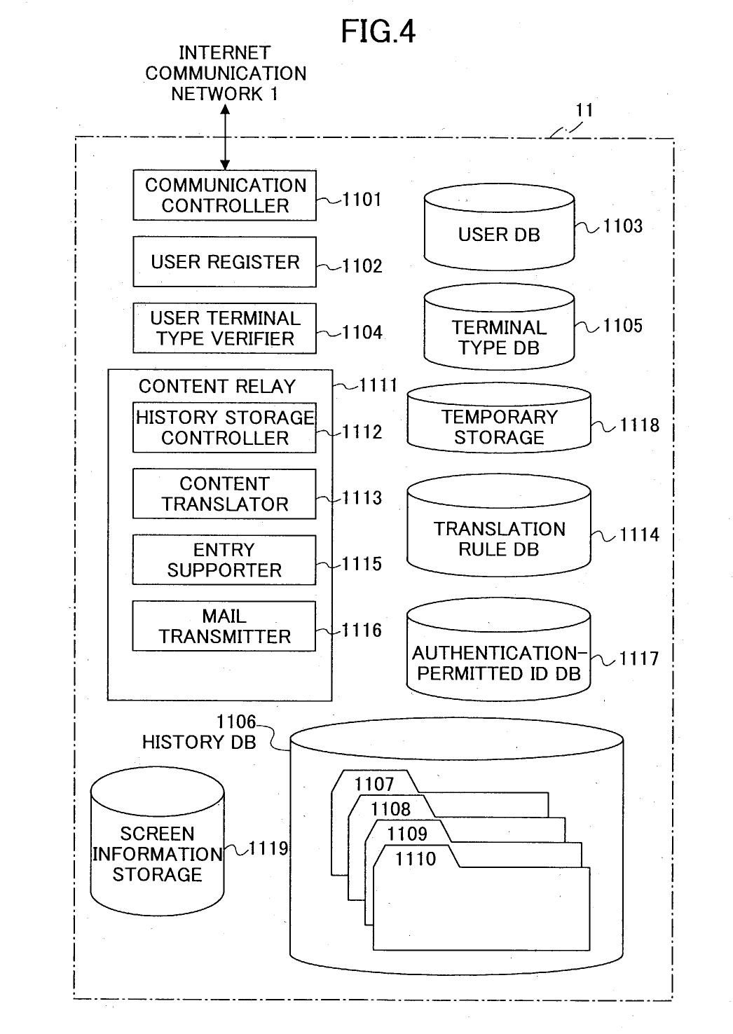

Finally, a description will be given, with reference to FIG. 4, of the content relay server 11.

FIG. 4 shows a configuration of the content relay server 11. In FIG. 4, a communication controller (a communicating part) 1101 performs a communication with the Internet communication network 1. A user register 1102 communicates with the user portable terminal 7 or the user terminal 5, etc., so as to store registration (identification) information of a user in a user DB 1103. A user terminal type verifier 1104 verifies a terminal type of the user terminal 5 or the user portable terminal 7 with which the user register 1102 communicates, by using information stored in a terminal type DB 1105. Content browse history, entry history and so forth for each user ID registered in the user DB 1103 is stored in a history DB 1106. Specifically, in the history DB 1106, the above-mentioned histories are stored in history folders corresponding to the respective user IDs (a history folder 1107 for a user ID “AAAAA”, a history folder 1108 for a user ID “BBBBB”, a history folder 1109 for a user ID “CCCCC”, a history folder 1110 for a user ID “DDDDD”). A content relay 1111 performs a relaying process between the servers connected to the Internet communication network 1 and the user terminal 5 or the user portable terminal 7. The content relay 1111 comprises a history storage controller 1112, a content translator 1113, an entry supporter 1115, a mail transmitter 1116, and an authentication-permitted ID DB 1117. The history storage controller 1112 stores the content browse history, the entry history and so forth of each user in the history DB 1106. The content translator 1113 performs a language translation of content information by using rule information stored in a translation rule DB (a language translation rule storage) 1114. The entry supporter 1115 performs an entry support by using information stored in the history DB 1106 when content information sent from the content providing server includes an entry field. The mail transmitter 1116 transmits content information to a specified destination as a mail with an attachment file. A user ID for which an authentication is permitted according to the user ID and a password sent from the user terminal 5 or the user portable terminal 7 is stored in the authentication-permitted ID DB 1117. In addition, a temporary storage 1118 is used for temporary storage by the above-described elements provided in the content relay server 11, and information of various screens is stored in a screen information storage 1119. Besides, each of the history DB 1106 and the temporary storage 1118 forms a history storage for storing history information upon the relaying process.

Hereinbelow, a description will be given of operations of the content system having the above-described configuration.

### USER-ID REGISTRATION PROCESS

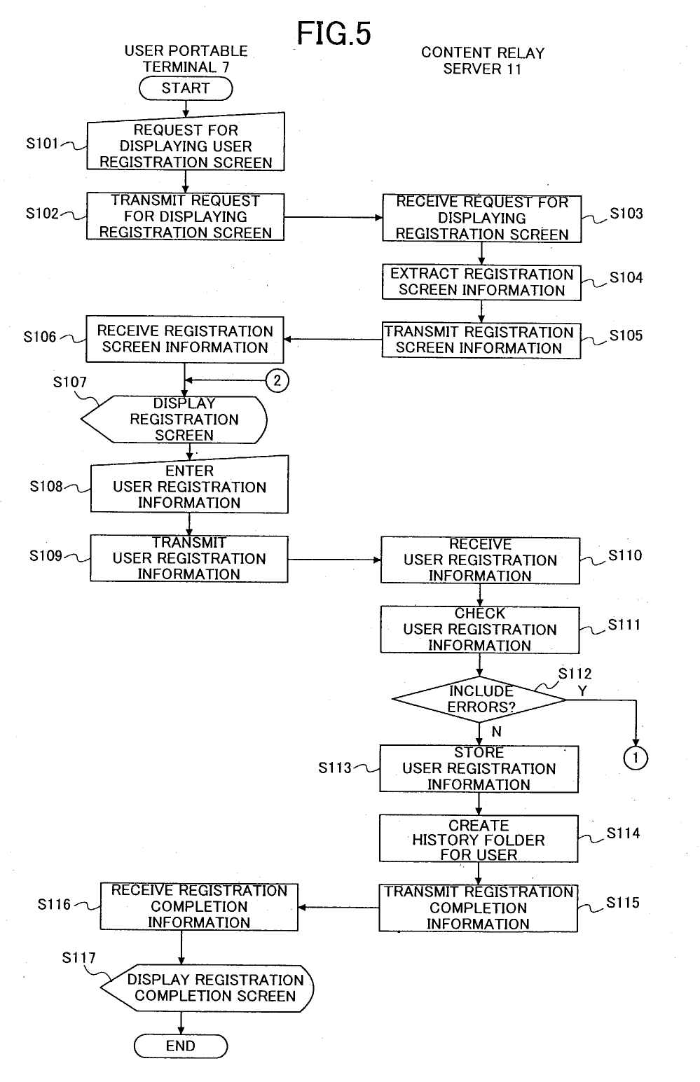

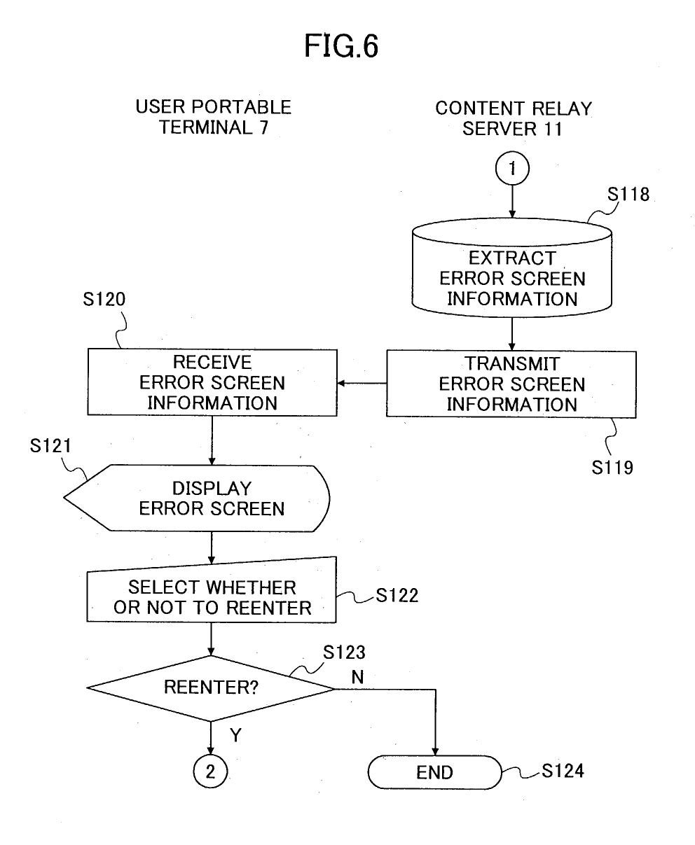

First, a description will be given, with reference to FIG. 5 and FIG. 6, of a procedure for registering a user in the content relay server 11.

In the present embodiment, a user registers by using the user portable terminal 7. Besides, a user may register not only by using the user portable terminal 7 but also by using the user terminal 5 or the server administration terminal 12 according to a similar procedure.

Besides, in the following description, it is described that the user portable terminal 7 and the content relay server 11 intercommunicate directly. However, as described hereinbefore, the user portable terminal 7 and the content relay server 11 intercommunicate via the wireless relay station 8, the wireless communication network 9, the POI 10 and the Internet communication network 1 by controlling the wireless communicator 701 to connect to the wireless relay station 8.

First, the user performs a request for displaying a user registration screen of the content relay server 11 by using the keyboard 703 of the user portable terminal 7 (S101). Upon receiving this request, the Internet browser 702 transmits information of the request for displaying the registration screen to the content relay server 11 (S102).

When the user register 1102 receives this information via the communication controller 1101 of the content relay server 11 (S103), the user register 1102 extracts registration screen information stored in the screen information storage 1119 (S104), and transmits this registration screen information to the user portable terminal 7 (S105).

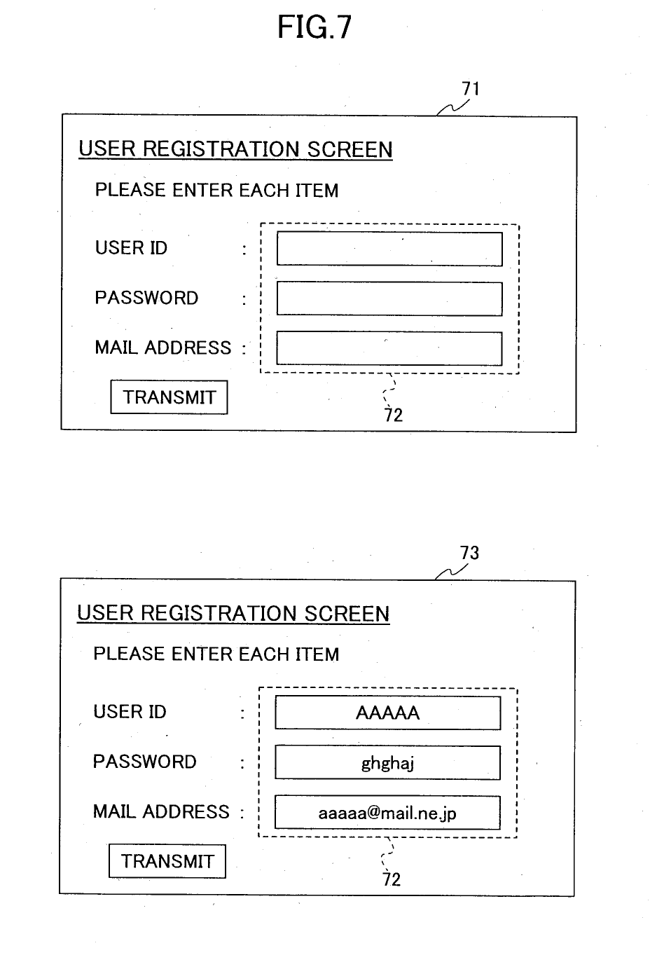

When the Internet browser 702 of the user portable terminal 7 receives this registration screen information via the wireless communicator 701 (S106), the Internet browser 702 displays a request for entering a user ID, a password and a mail address, and entry frames 72 for entering these items, on the display 704, as displayed on a screen 71 shown in FIG. 7, according to the received registration screen information (S107).

When the user enters these items from this screen by using the keyboard 703, etc., the Internet browser 702 displays the items entered in the entry frames 72 on the display 704, as displayed on a screen 73 shown in FIG. 7 (S108).

In this state, when the user performs a transmission operation by using the keyboard 703, etc., the Internet browser 702 controls the wireless communicator 701 to transmit information of the entered items to the content relay server 11 as user registration information (S109).

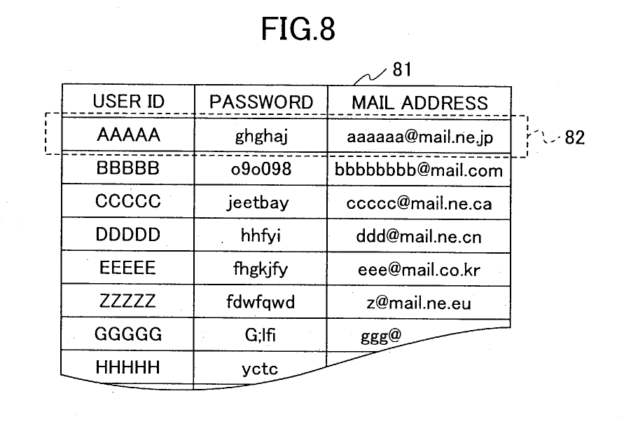

When the user register 1102 receives this user registration information via the communication controller 1101 (S110), the user register 1102 checks whether or not the user registration information includes errors (for example: the user registration information includes prohibited characters; the user registration information is already registered in the user DB 1103) (S111). When the user registration information includes no errors (N in S112), the user register 1102 stores the user registration information in the user DB 1103. This user registration information is stored therein with the user ID, the password and the mail address being related to one another, as stored in a user registration table 81 shown in FIG. 8 (S113). In this example, the user enters “user ID: AAAAA”, “password: ghghaj” and “mail address: aaaaa@mail.ne.jp”; accordingly, this user registration information is registered as items 82 in the user registration table 81 shown in FIG. 8. Other items in the user registration table 81 are also registered by the user register 1102 based on user registration information transmitted from either the user terminal 5, the user portable terminal 7 or the server administration terminal 12, according to a similar registering procedure. Additionally, in this course, the user register 1102 creates the history folder 1107 for the user ID “AAAAA” in the history DB 1106 (S114).

Upon completion of these processes, the user register 1102 extracts screen information indicating completion of the registration from the screen information storage 1119, and controls the communication controller 1101 to transmit this information to the user portable terminal 7 (S115).

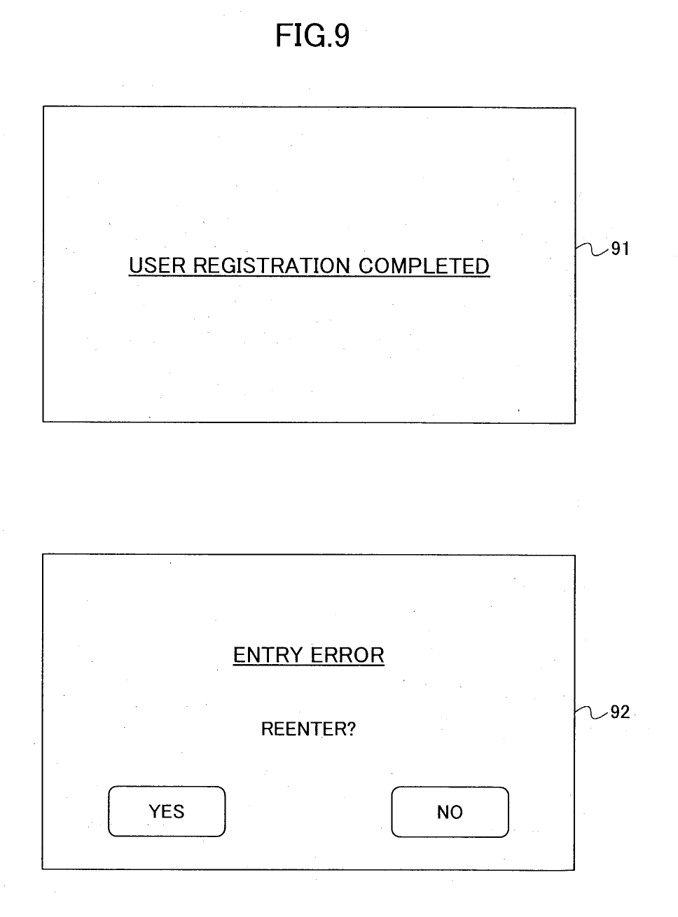

When the Internet browser 702 receives this information via the wireless communicator 701 (S116), the Internet browser 702 displays an indication of the completion of the registration on the display 704, as displayed on a screen 91 shown in FIG. 9, according to the received information (S117), and ends the procedure.

On the other hand, in the foregoing step S112, when the user register 1102 judges that the user registration information includes an error (Y in S112), a procedure shown in FIG. 6 is performed. Specifically, the user register 1102 of the content relay server 11 extracts error screen information from the screen information storage 1119 (S118), and transmits this error screen information to the user portable terminal 7 (S119). When the Internet browser 702 of the user portable terminal 7 receives this error screen information via the wireless communicator 701 (S120), the Internet browser 702 displays a notice of entry error and an indication of prompting reentry on the display 704, as displayed on a screen 92 shown in FIG. 9, according to the received error screen information (S121).

From this screen, by operating the keyboard 703, etc., the user selects whether or not to perform a reentry (S122). When the user selects to perform a reentry (Y in S123), the Internet browser 702 transits to the foregoing step S107 shown in FIG. 5 for the reentry, and performs the processes regarding the entry of the above-mentioned entry items again. On the other hand, in the foregoing step S123, when the user selects not to perform a reentry (N in S123), the registering procedure ends (S124).

As described above, information related to each user ID is registered in the content relay server 11, and a folder for storing history information of the user ID is prepared therein.

### CONTENT RELAY PROCESS

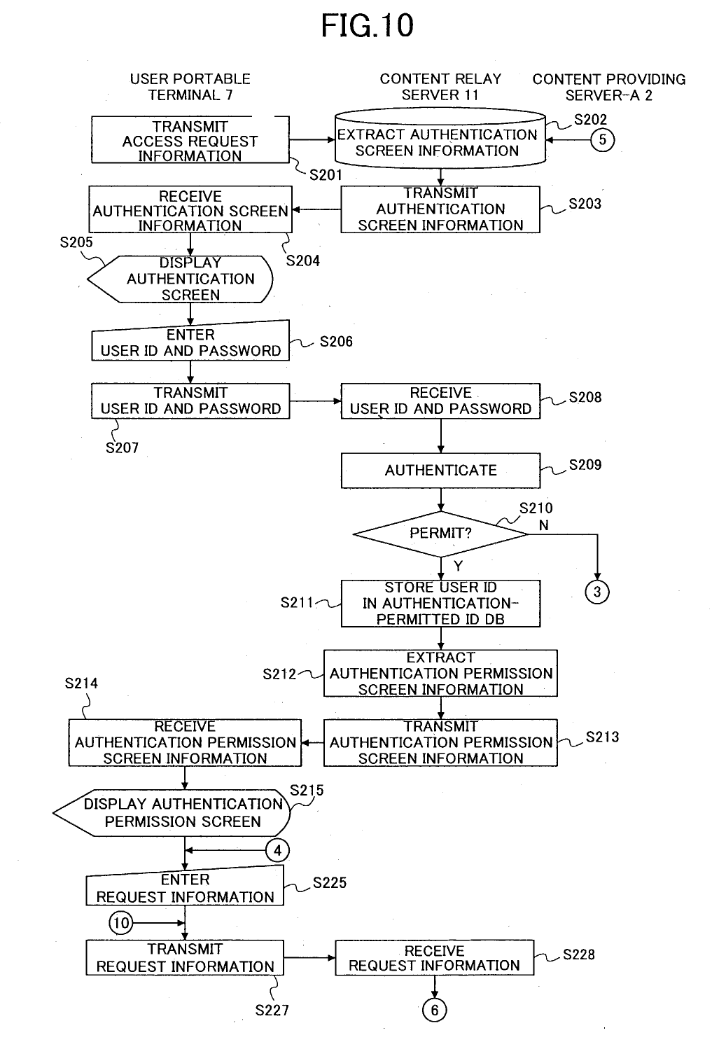

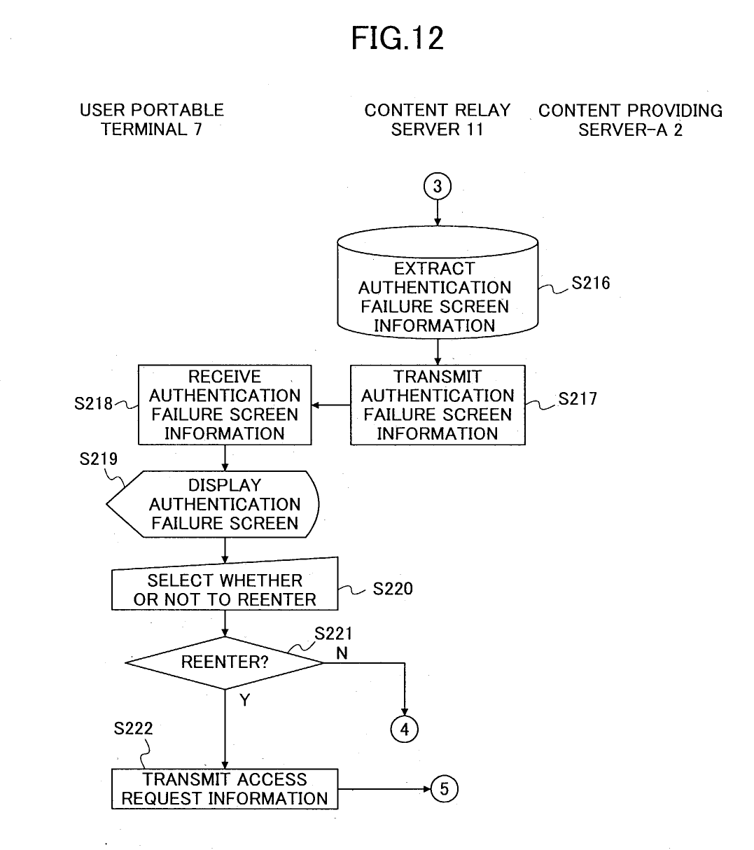

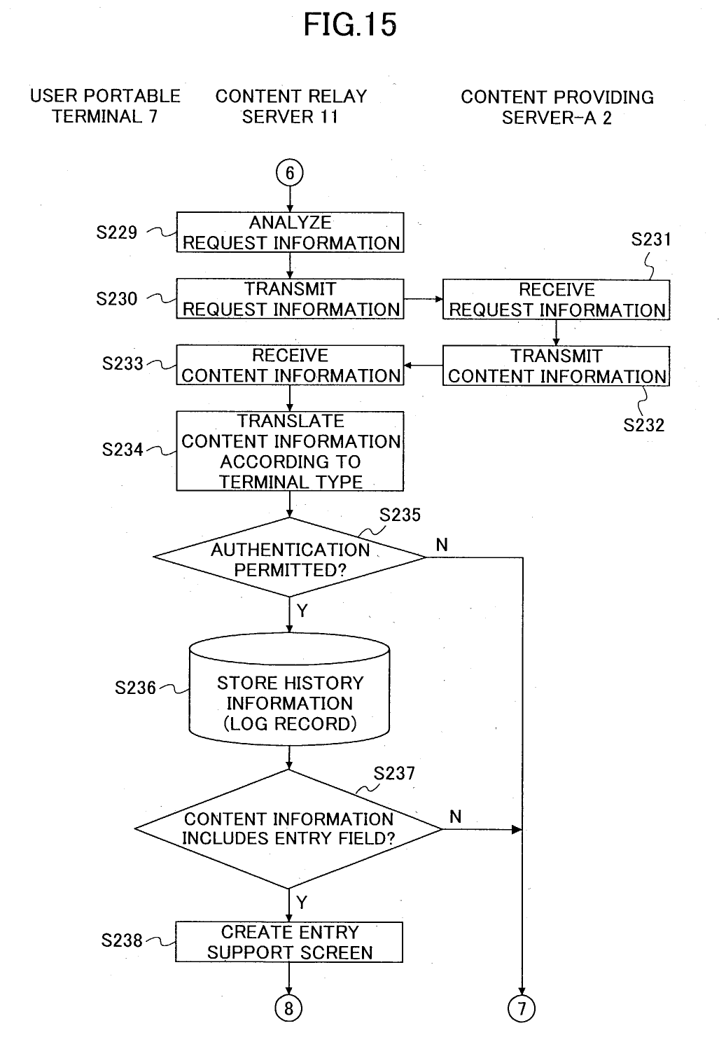

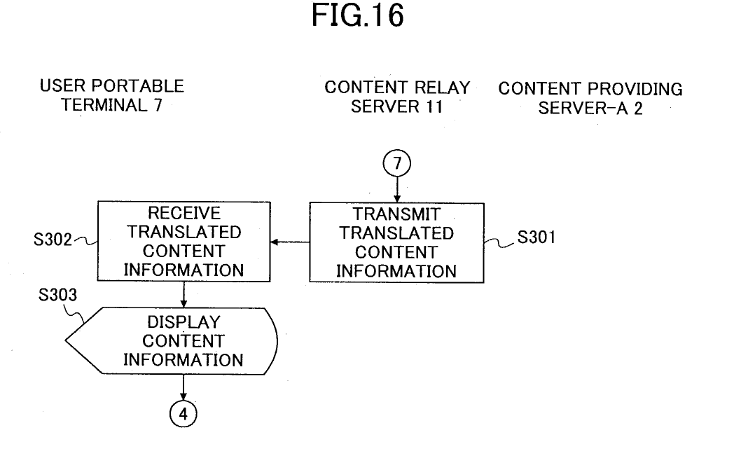

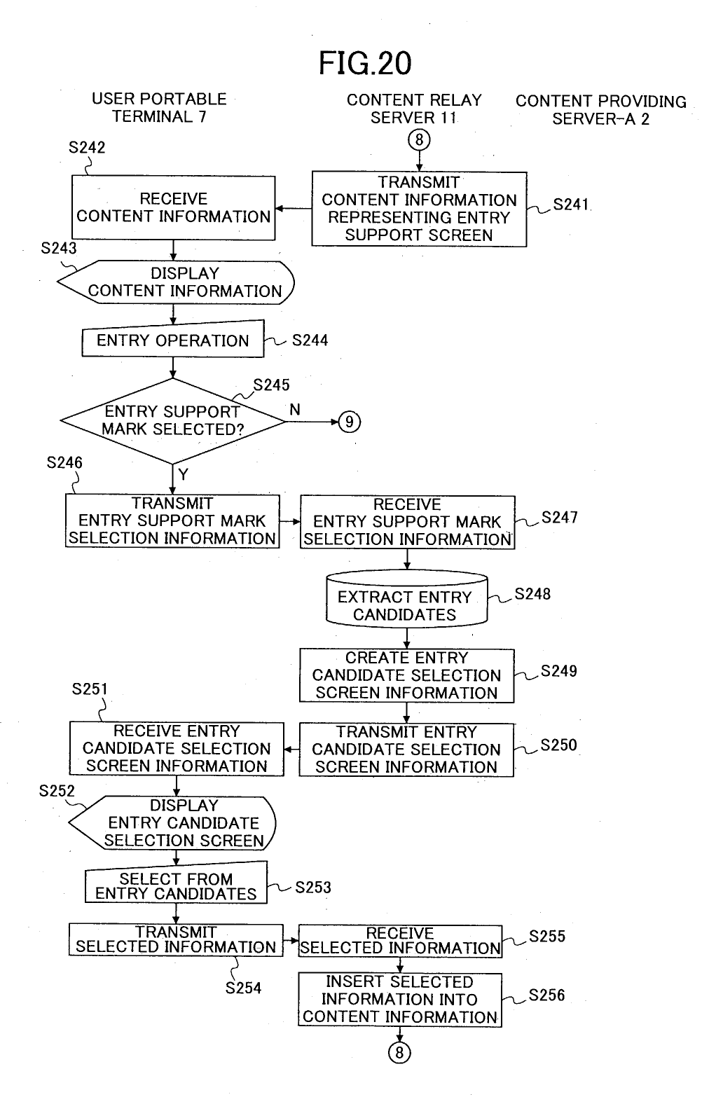

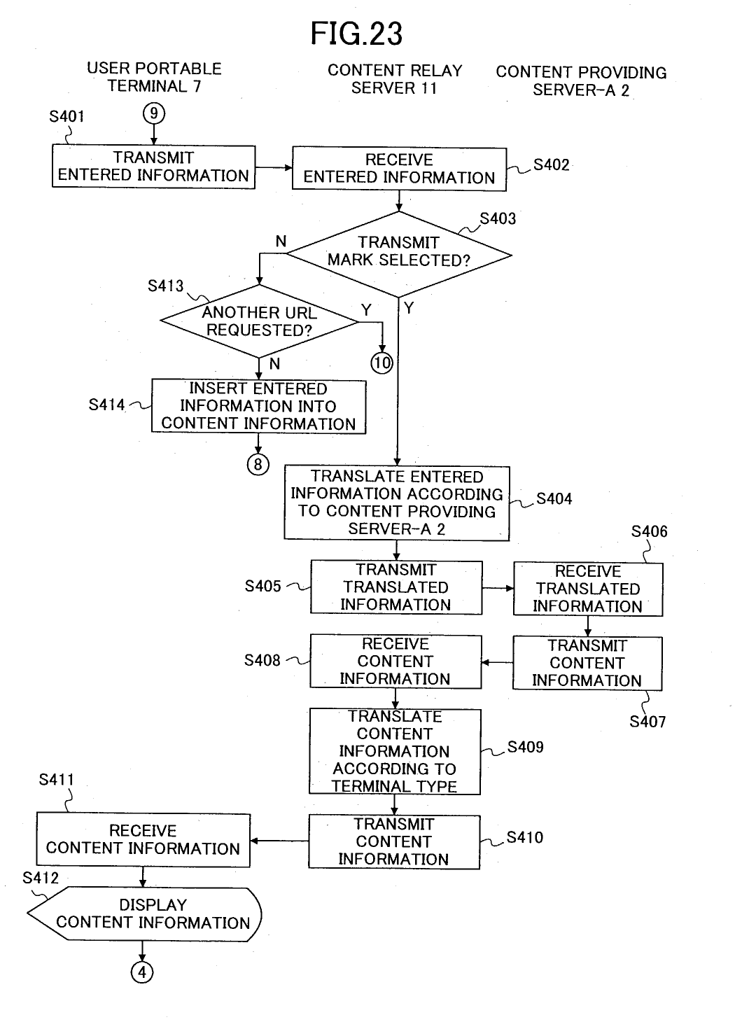

Next, a description will be given, with reference mainly to flowcharts shown in FIG. 10, FIG. 12, FIG. 15, FIG. 16, FIG. 20 and FIG. 23, of a communication process between the user portable terminal 7 and the content providing server-A 2 via the content relay server 11 storing user IDs as described above. In the present embodiment, the user portable terminal 7 communicates with the content providing server-A 2 according to a hereinbelow-described procedure. Additionally, the user portable terminal 7 can communicate with other servers, such as the content providing server-B 3 and the content providing server-C 4 according to a similar procedure. Further, the user terminal 5 can communicate with each of the content providing servers via the content relay server 11 according to a similar procedure. Besides, the user portable terminal 7 and the content relay server 11 intercommunicate basically via the wireless relay station 8, the wireless communication network 9, the POI 10 and the Internet communication network 1. Further, the content relay server 11 and the content providing server-A 2 intercommunicate basically via the Internet communication network 1.

First, when the user requests an access to the content relay server 11 by using the keyboard 703 of the user portable terminal 7, the Internet browser 702 transmits information of the access request to the content relay server 11 (S201).

When the content relay 1111 of the content relay server 11 receives this information via the communication controller 1101, the content relay 1111 extracts authentication screen information from the screen information storage 1119 (S202), and transmits this authentication screen information to the user portable terminal 7 (S203).

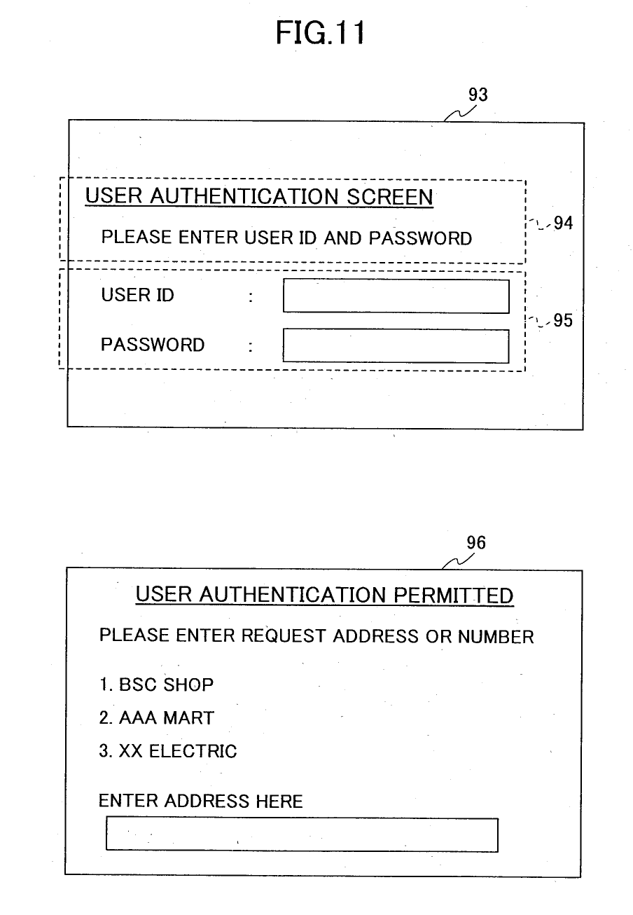

When the Internet browser 702 of the user portable terminal 7 receives this authentication screen information via the wireless communicator 701 (S204), the Internet browser 702 displays a message 94 prompting the user to enter a user ID and a password, and entry frames 95 for entering the user ID and the password, on the display 704, as displayed on a screen 93 shown in FIG. 11, according to the received authentication screen information (S205).

When the user enters the user ID and the password in the entry frames 95 from this screen by using the keyboard 703 (S206), the Internet browser 702 controls the wireless communicator 701 to transmit information of the user ID and the password to the content relay server 11 (S207).

When the content relay 1111 receives this information via the communication controller 1101 (S208), the content relay 1111 performs an authentication by comparing the received information of the user ID and the password with user registration information stored in the user DB 1103 (S209). Thus, the content relay 1111 forms a user information obtaining part for obtaining the user registration information from the user portable terminal 7. When the content relay 1111 permits the authentication of the user ID (Y in S210), the content relay 1111 stores the user ID in the authentication-permitted ID DB 1117 (S211). That is, information registered in the authentication-permitted ID DB 1117 is a user ID of a user currently connecting to the content relay server 11 among user IDs of users stored in the user DB 1103.

Then, the content relay 1111 extracts authentication permission screen information from the screen information storage 1119 (S212), and controls the communication controller 1101 to transmit this authentication permission screen information to the user portable terminal 7 (S213).

When the Internet browser 702 receives this authentication permission screen information via the wireless communicator 701 (S214), the Internet browser 702 displays a screen noticing the authentication permission on the display 704 according to the received authentication permission screen information (S215). This screen prompts the user to select items of content information or to enter a URL which the user requests, as displayed on a screen 96 shown in FIG. 11. After this process, a substantial part of the relaying process commences from step S225.

On the other hand, in the foregoing step S210, when the content relay 1111 cannot permit the authentication of the user ID (N in S210), the content relay 1111 extracts authentication failure screen information indicating the failure of the authentication from the screen information storage 1119 (S216 in FIG. 12), and controls the communication controller 1101 to transmit this authentication failure screen information to the user portable terminal 7 (S217).

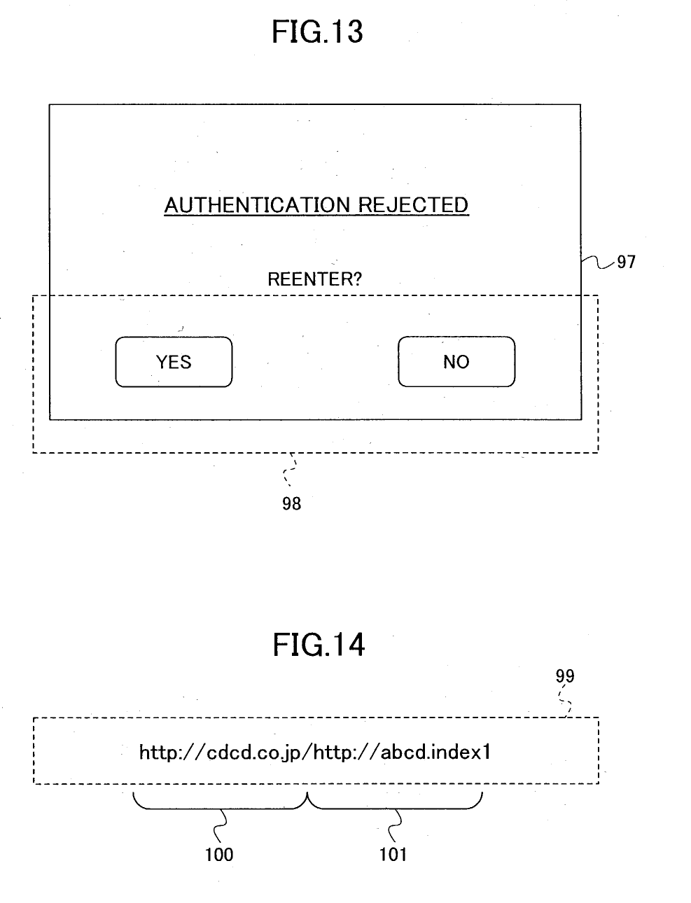

When the Internet browser 702 of the user portable terminal 7 receives this authentication failure screen information via the wireless communicator 701 (S218), the Internet browser 702 displays a screen 95 indicating the failure of the authentication on the display 704, as shown in FIG. 13, according to the received authentication failure screen information (S219).

This screen 95 includes information 98 asking whether or not to reenter. From this screen, by using the keyboard 703, the user selects whether or not to reenter (S220). When the Internet browser 702 judges that the user selects to reenter (Y in S221), the Internet browser 702 controls the wireless communicator 701 to transmit the information of the access request to the content relay server 11 again (S222). Thereafter, the procedure transits to the foregoing step S202 shown in FIG. 10.

On the other hand, when the Internet browser 702 judges that the user selects not to reenter (N in S221), the procedure transits to step S225 shown in FIG. 10. That is, when the user portable terminal 7 communicates via the content relay server 11 without an authentication, the substantial part of the relaying process is performed without the user ID being registered in the authentication-permitted ID DB 1117.

After the foregoing step S215, or after the Internet browser 702 judges that the user selects not to reenter in the foregoing step S221, the user enters content request information by using the keyboard 703 of the user portable terminal 7 (S225). Thereupon, the Internet browser 702 controls the wireless communicator 701 to transmit the request information to the content relay server 11 (S227). In the present embodiment, the request information includes a URL 100 as an address in the content relay server 11 followed by a URL 101 as an address in the content providing server, as described in request information 99 shown in FIG. 14.

When the content relay 1111 of the content relay server 11 receives this request information via the communication controller 1101 (S228), the content relay 1111 analyzes the request information so as to extract the URL 101 of the content providing server (S229 in FIG. 15), and uses the communication controller 1101 to transmit the request information to the address represented by the URL 101 (S230).

When the content providing server-A 2 receives this request information (S231), the content providing server-A 2 transmits content information corresponding to the request information to the content relay server 11 (S232).

When the content relay 1111 receives this content information via the communication controller 1101 (S233), the content relay 1111 stores the content information in the temporary storage 1118, and starts the content translator 1113. Thus, the content relay 1111 forms a content information obtaining part for obtaining the content information from the content providing server-A 2. The content translator 1113 refers to the terminal type DB 1105 so as to translate the content information stored in the temporary storage 1118 into a language used by the user portable terminal 7 that has transmitted the request information, and stores the translated content information again in the temporary storage 1118 (S234). This translation is performed according to a procedure substantially similar to a procedure described in the above-mentioned patent application filed by the applicant of the present application, and thus will not be described herein.

Subsequently, the content relay 1111 verifies whether or not the user ID of the user portable terminal 7 is authenticated, i.e., whether or not the user ID is stored in the authentication-permitted ID DB 1117 (S235).

When the content relay 1111 judges that the user ID of the user portable terminal 7 is not authenticated (N in S235), the relaying process is continued to step S301 and so forth shown in a flowchart of FIG. 16 without performing a log record process or an entry history process. The flowchart of FIG. 16 will be described hereinafter.

When the content relay 1111 judges that the user ID is stored in the authentication-permitted ID DB 1117, i.e., that the user ID is authenticated (Y in S235), the content relay 1111 starts the history storage controller 1112 so as to store the actually accessed content information together with an access time thereof as history information in the folder prepared for the user ID in the history DB 1106 (S236).

In the present embodiment, the user portable terminal 7 is authenticated according to the user ID “AAAAA”, i.e., the user ID “AAAAA” is registered in the authentication-permitted ID DB 1117. Accordingly, the above-mentioned history information is stored in the folder 1107 prepared for the user ID “AAAAA” in the history DB 1106.

Subsequently, the content relay 1111 checks whether or not the content information stored in the temporary storage 1118 includes an entry field, i.e., information regarding an entry frame for the user to enter (S237).

When the content relay 1111 judges that the content information includes no entry field (N in S237), the process starting from step S301 shown in FIG. 16 is performed as follows.

First, the content relay 1111 controls the communication controller 1101 to transmit the translated content information stored in the temporary storage 1118 to the user portable terminal 7 (S301). Thus, the content relay 1111 forms a transmitting part for transmitting the content information to the user portable terminal 7. When the Internet browser 702 receives this translated content information via the wireless communicator 701 (S302), the Internet browser 702 displays the content information on the display 704 according to the translated content information (S303), and returns to the foregoing step S225 shown in FIG. 10 so as to accept a next request from the user.

On the other hand, in the foregoing step S237 shown in FIG. 15, when the content relay 1111 judges that the content information includes at least one entry field (Y in S237), the content relay 1111 starts the entry supporter 1115.

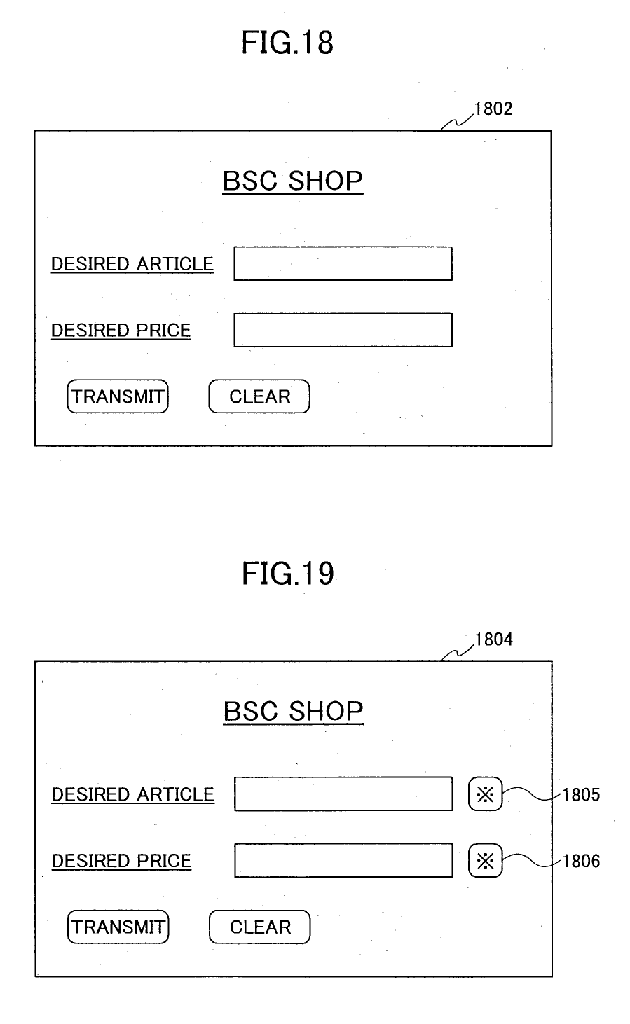

The entry supporter 1115 creates an entry support screen (S238) according to a hereinbelow-described procedure. In this procedure, for example, an address “www.abcd.index1” in the content providing server-A 2 is specified, and content information including entry fields for entering a desired article and a desired price as displayed on a screen 1802 shown in FIG. 18 is obtained from the content providing server-A 2. In this state, the history folder 1107 prepared for the user ID “AAAAA” in the history DB 1106 is referred to.

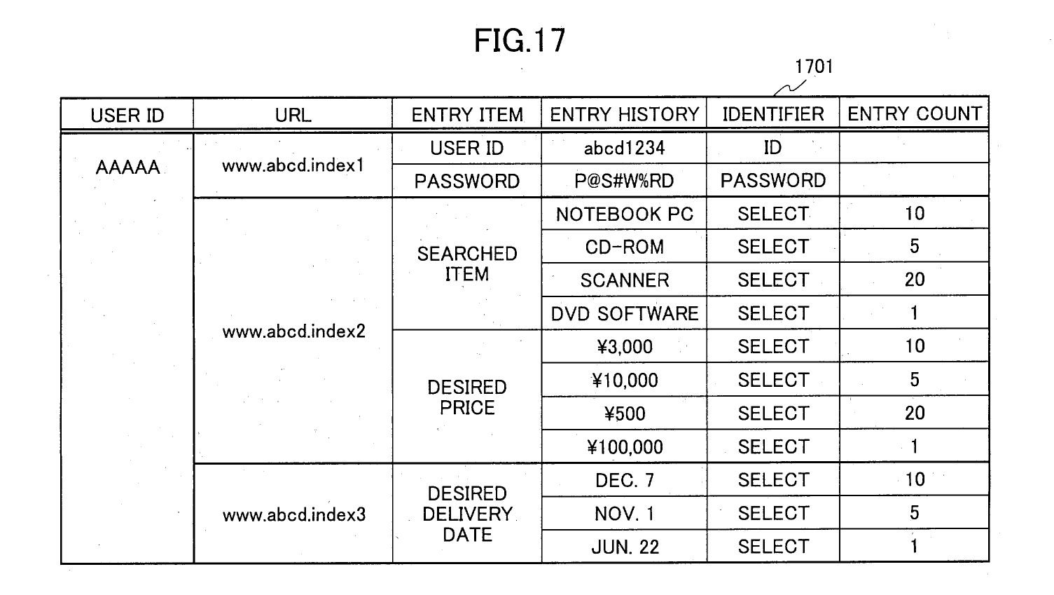

Here, a description will be given, with reference to a folder table 1701 shown in FIG. 17, of contents stored in entry fields in the history folder 1107. As shown in FIG. 17, a URL as an address of requested content information, entry items, information entered in the entry items, and identifiers identifying whether or not the entry items are authentication items, are stored in the folder table 1701 with being related to one another. Additionally, entry count information indicating the number of times the information is entered is also stored in the folder table 1701 with being related thereto. This information is an identifier provided for identifying the number of times a variety of entries is made to a same entry item at a same address.

As shown in the folder table 1701 in FIG. 17, history information previously entered in entry items (a searched item (a desired article) and a desired price) at a corresponding URL is stored in the folder 1107. In this case, content information including the entry items and entry support marks 1805 and 1806 beside the entry items, as represented in a screen 1804 shown in FIG. 19, is created.

Thereafter, the entry supporter 1115 stores the thus created content information again in the temporary storage 1118.

Then, the entry supporter 1115 controls the communication controller 1101 to transmit the content information created as above in the step S238 and stored in the temporary storage 1118 to the user portable terminal 7 (S241 in FIG. 20). Thus, the entry supporter 1115 forms a transmitting part for transmitting the content information to the user portable terminal 7.

When the Internet browser 702 of the user portable terminal 7 receives this content information via the wireless communicator 701 (S242), the Internet browser 702 displays the content information on the display 704 (S243). Specifically, the Internet browser 702 displays the content information that is transmitted from the content providing server-A 2 and is provided with the entry support marks 1805 and 1806, as displayed on the screen 1804 shown in FIG. 19.

From this screen, when the user performs an entry operation by using the keyboard 703 (S244), the Internet browser 702 verifies whether or not either the entry support mark 1805 or 1806 is selected by the entry operation (S245). When the Internet browser 702 judges that either the entry support mark 1805 or 1806 is selected (Y in S245), the Internet browser 702 controls the wireless communicator 701 to transmit entry support mark selection information (indicating which of the entry support marks 1805 and 1806 is selected) to the content relay server 11 (S246). In the present embodiment, the entry support mark 1805 is selected, for example, and entry support mark selection information indicating this selection is transmitted to the content relay server 11.

When the entry supporter 1115 of the content relay server 11 receives this information via the communication controller 1101 (S247), the entry supporter 1115 extracts entry history information (entry candidates) corresponding to this information from the history folder 1107 prepared for the user ID “AAAAA” in the history DB 1106 (S248). Thus, the entry supporter 1115 forms an extracting part for extracting the entry history information from the history DB 1106 according to the user registration information (including the user ID) and the entry support mark selection information regarding the content information. In the present embodiment, since the entry support mark 1805 corresponding to the entry field of the desired article is selected, entry history information corresponding to the entry item of the searched item (desired article) at a corresponding URL (www.abcd.index2) is extracted, the entry history information including “notebook PC”, “CD-ROM”, “scanner” and “DVD software”.

At this point, the entry supporter 1115 creates “entry candidate selection screen information” used by the user to select from contents of the previous entry information. This entry candidate selection screen information is created according to the following procedure: the contents of the entry history information extracted from the history folder 1107 are arranged in descending order of the number of times the contents were entered previously according to the entry count information stored in the history folder 1107; and a screen displaying the arranged contents of the entry history information is created. In the present embodiment, the entry count information corresponding to the contents of the entry history information are as follows:

“Notebook PC” entry count: 10

“CD-ROM” entry count: 5

“Scanner” entry count: 20

“DVD software” entry count: 1

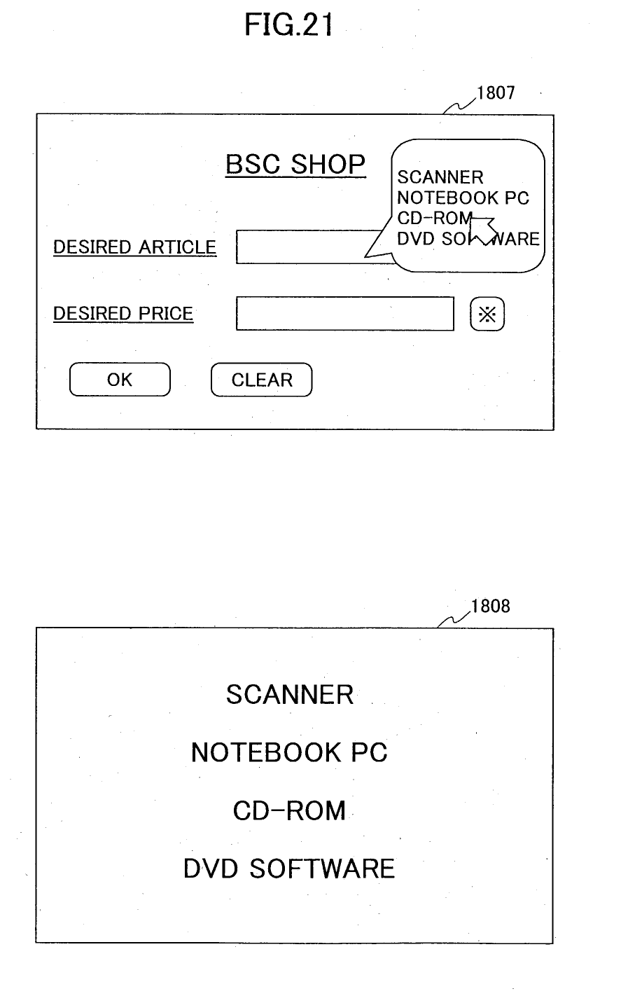

Accordingly, the contents of the entry history information are arranged in the order of “scanner”, “notebook PC”, “CD-ROM” and “DVD software”, and a screen additionally displaying the previously entered contents (entry candidates) arranged in this order is created, as displayed on a screen 1807 shown in FIG. 21 (S249).

Besides, when the display 704 of the user portable terminal 7 is so small as to make the screen 1807 shown in FIG. 21 not easily recognizable in which the previously entered contents (the entry candidates) are overlapped on the original screen. In this case, only the previously entered contents (the entry candidates) may be independently displayed as in a screen 1808 shown in FIG. 21.

The entry supporter 1115 controls the communication controller 1101 to transmit the entry candidate selection screen information created as above to the user portable terminal 7 (S250). Thus, the entry supporter 1115 forms a transmitting part for transmitting the entry candidate selection screen information including the entry history information to the user portable terminal 7.

When the Internet browser 702 of the user portable terminal 7 receives this entry candidate selection screen information via the wireless communicator 701 (S251), the Internet browser 702 displays the screen 1807 or the screen 1808 shown in FIG. 21 on the display 704 according to the entry candidate selection screen information (S252).

From this screen, when the user selects either of the entry candidates by using the keyboard 703 (S253), the Internet browser 702 controls the wireless communicator 701 to transmit information regarding this selection to the content relay server 11 (S254). In the present embodiment, the “CD-ROM” is selected, for example, and information regarding this selection is transmitted to the content relay server 11.

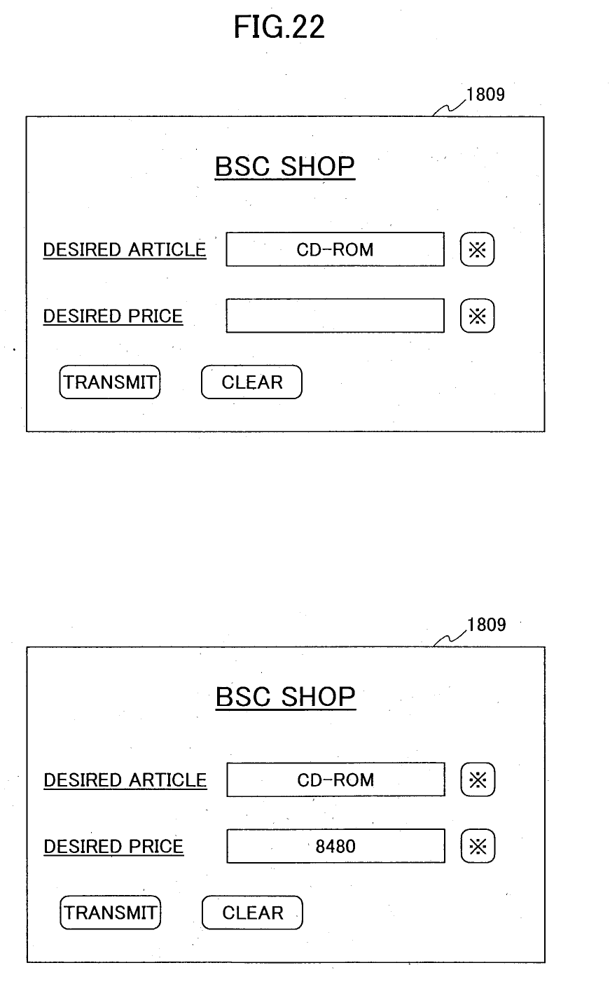

When the entry supporter 1115 of the content relay server 11 receives this information regarding the selection via the communication controller 1101 (S255), the entry supporter 1115 creates content information by inserting the received information regarding the selection into the foregoing content information obtained from the content providing server-A 2 and then translated which is stored in the temporary storage 1118 (S256). In the present embodiment, since the “CD-ROM” is selected, content information as displayed on a screen 1809 shown in FIG. 22 is created. Thus, a screen is created in which the “CD-ROM” is inserted into the entry field of the desired article, and the procedure returns to the foregoing step S241. In this course, the information inserted into this entry field, i.e., the information regarding the selection transmitted from the user portable terminal 7, is stored in the temporary storage 1118. Subsequently, the content information created as above is retransmitted to the user portable terminal 7, and the entry operation supported by the entry supporter 1115 is continued.

In the foregoing step S245, when the Internet browser 702 judges that neither the entry support mark 1805 nor 1806 is selected (N in S245), the entry operation in the step S244 may be performed without the support by the entry supporter 1115. In this case, the entry operation in the step S244 may be performed as follows, for example: information is directly entered into the entry fields of the screen 1804 shown in FIG. 19; and a “transmit” mark is selected so as to transmit the information entered in the entry fields to the content providing server-A 2, a “clear” mark is selected so as to clear the information entered in the entry fields, or a request of another URL is made.

In this case, a procedure is preformed according to a flowchart shown in FIG. 23.

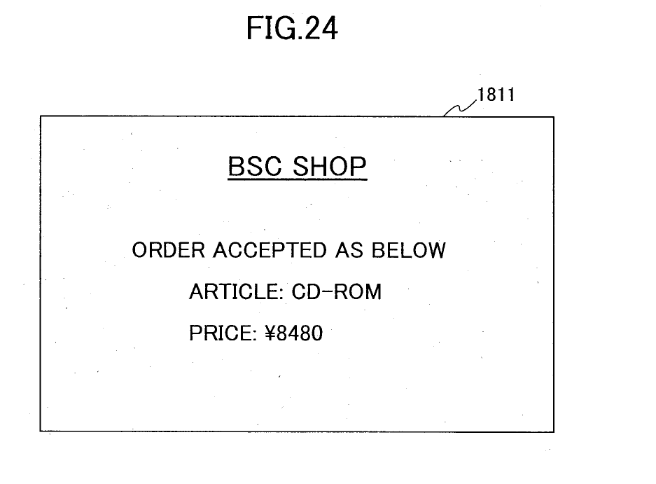

First, the Internet browser 702 controls the wireless communicator 701 to transmit the information entered in the foregoing step S244 shown in FIG. 20 to the content relay server 11 (S401). When the content relay 1111 of the content relay server 11 receives this information via the communication controller 1101 (S402), the content relay 1111 judges whether or not the entered information is the “transmit mark being selected” (S403). When the content relay 1111 judges that the transmit mark is selected (Y in S403), the content relay 1111 starts the content translator 1113. By using the translation rule DB 1114, the content translator 1113 translates the information entered (or selected) in the entry fields, which has been stored in the temporary storage 1118, into a language used by the content providing server-A 2 (S404). The content relay 1111 controls the communication controller 1101 to transmit this translated information to the content providing server-A 2 (S405). When the content providing server-A 2 receives this information (S406), the content providing server-A 2 returns content information corresponding to an acceptance of the received information (i.e., content information indicating that the entered information is accepted) to the content relay server 11 (S407). When the content relay 1111 of the content relay server 11 receives this content information via the communication controller 1101 (S408), the content relay 1111 starts the content translator 1113. By referring to the translation rule DB 1114, the content translator 1113 translates the received content information into the language used by the user portable terminal 7 (S409). The content relay 1111 controls the communication controller 1101 to transmit this translated content information to the user portable terminal 7 (S410). When the Internet browser 702 of the user portable terminal 7 receives this content information via the wireless communicator 701 (S411), the Internet browser 702 displays a screen according to the received content information (S412). This screen displays the content information that indicates that the content providing server-A 2 accepts the entered information and is translated into the language used by the user portable terminal 7, as described above; thus, the Internet browser 702 displays, for example, a screen 1811 shown in FIG. 24.

After the step S412, the Internet browser 702 transits to the foregoing step S225 shown in FIG. 10 so as to accept a next operation from the user.

In the foregoing step S403, when the content relay 1111 judges that the transmit mark is not selected (N in S403), the content relay 1111 judges whether or not the entered information is the request of another URL (S413). When the content relay 1111 judges that the entered information is the request of another URL (Y in S413), the Internet browser 702 transits to the foregoing step S227 shown in FIG. 10 so as to perform a process for the request of another URL.

On the other hand, when the content relay 1111 judges that the entered information is not the request of another URL, i.e., that the entered information is neither the “transmit mark” being selected nor the request of another URL (N in S413), the content relay 1111 provides the content information stored in the temporary storage 1118 with a process corresponding to the entered information (e.g., clearing of information entered in the entry fields, insertion of entered information into the entry fields, etc.). Then, the procedure transits to the foregoing step S241 shown in FIG. 20. That is, processes regarding the currently displayed entry fields are continued.

As described above, in the content relay process according to the present embodiment, a history folder is prepared for each user ID in the content relay server 11 so that history for each user ID is stored in this history folder, and according to the stored information, the content relay server 11 performs an entry support to entry fields displayed on the user terminal 5 or the user portable terminal 7. Accordingly, in this content relay process, the content relay server 11, which communicates directly with the content providing server-A 2, manages communication history with the content providing server-A 2. Therefore, it becomes possible to make a reentry using entry information previously made upon connecting to the same content, and to obtain history information of contents actually browsed previously.

Additionally, even when a terminal used by a user is not provided with a function, such as Cookie, the terminal can utilize entry history and browse history. Therefore, even with a terminal, such as a portable Internet terminal, which is incapable of using the Cookie due to a capacity limit thereof, it becomes possible to make a reentry using previous browse history and previous entry history.

Besides, the content relay server 11 stores history for each user ID, as mentioned above. Accordingly, by connecting to the content providing server via the content relay server, a user who is using both a desktop terminal at home and a portable terminal can utilize history information browsed or entered by using the desktop terminal when using the portable terminal.

In this case, according to the present embodiment, since the content relay server 11 is capable of translating content information into a language used by each terminal, the user can perform a communication with a desired content providing server regardless of whatever types of the terminals; and further, information browsed or entered by using the terminals can be shared.

### CONTENT INFORMATION TRANSMISSION PROCESS

Upon connecting to the content providing server via the content relay server 11 as described above, redisplaying of content information previously displayed on the user terminal 5 or the user portable terminal 7 is also performed by a communication via the communication networks and the content relay server 11. For example, the user portable terminal 7 uses the wireless communication network 9: in many cases, a toll for using such wireless communication network is stipulated according to an amount of communicated data (an amount of packets) or a time of communication. Thus, a user has to pay the toll for only browsing the same information. Besides, when the same information is browsed necessarily via the content relay server 11, this imposes a heavy load on the content relay server 11.

As a countermeasure to these circumstances, the content relay server 11 according to the present embodiment has a function of transmitting browsed content information translated into a language used by the user terminal 5 or the user portable terminal 7, or an address of the content information, as electronic mail.

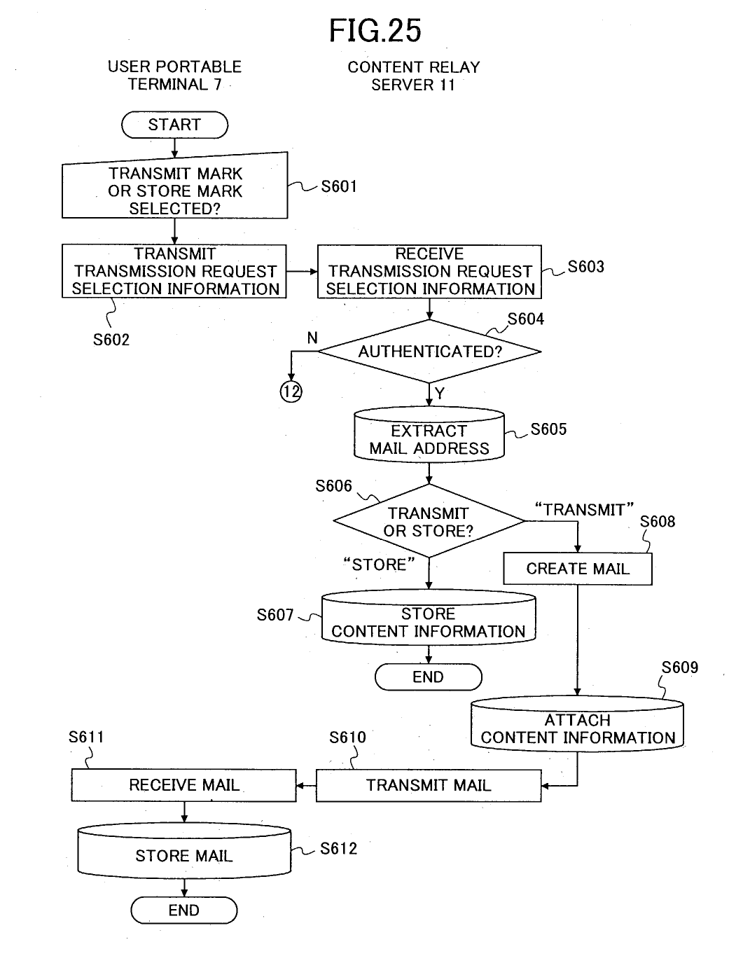

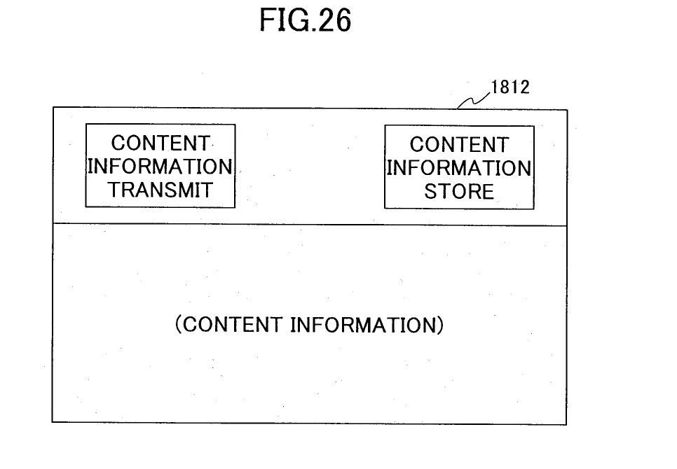

Hereinafter, a description will be given, with reference mainly to FIG. 25, of an operation of the function. In the following description, a user uses the user portable terminal 7. Besides, when the content relay 1111 transmits content information to the user portable terminal 7, the content relay 1111 creates the content information by adding a “content information transmit” mark and a “content information store” mark to former content information, as represented in a screen 1812 shown in FIG. 26. According to the received content information, the Internet browser 702 of the user portable terminal 7 displays the screen 1812 shown in FIG. 26 on the display 704.

In this state, when the user selects either the “content information transmit” mark or the “content information store” mark by using the keyboard 703 (S601), the Internet browser 702 transmits information regarding this selection to the content relay server 11 as transmission request selection information (S602).

When the content relay 1111 of the content relay server 11 receives this transmission request selection information via the communication controller 1101 (S603), the content relay 1111 starts the mail transmitter 1116. By referring to the user portable terminal 7, the mail transmitter 1116 verifies whether or not the user portable terminal 7 is authenticated according to the user ID (S604). When the mail transmitter 1116 judges that the user portable terminal 7 is authenticated (Y in S604), the mail transmitter 1116 extracts a mail address corresponding to the user ID from the user DB 1103 (S605). As described above, user registration information is stored in the user DB 1103 as represented in the user registration table 81 shown in FIG. 8. Accordingly, when the user portable terminal 7 is authenticated according to the user ID “AAAAA”, the mail transmitter 1116 extracts the mail address “aaaaa@mail.ne.jp” corresponding to the user ID “AAAAA”.

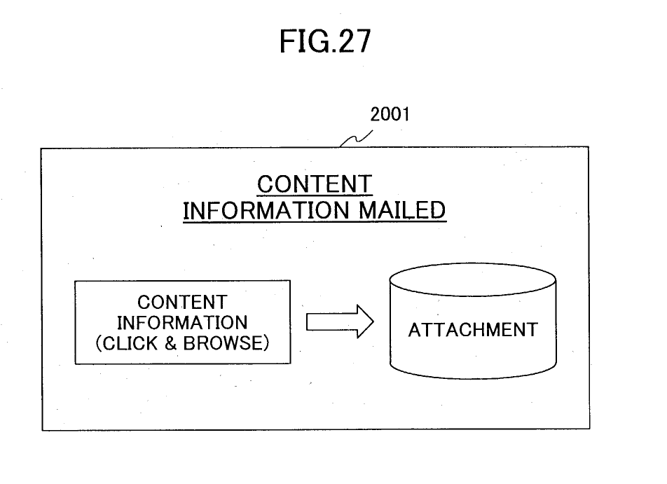

Next, the mail transmitter 1116 verifies which of the “content information transmit” mark and the “content information store” mark is indicated by the transmission request selection information (S606). When the mail transmitter 1116 judges that the “content information store” mark is indicated by the transmission request selection information (“STORE” in S606), the mail transmitter 1116 stores the content information in the history DB 1106 (S607). On the other hand, when the mail transmitter 1116 judges that the “content information transmit” mark is indicated by the transmission request selection information (“TRANSMIT” in S606), the mail transmitter 1116 creates a mail noticing the transmission of the content information, as read in a screen 2001 shown in FIG. 27 (S608), and extracts the content information, which has been transmitted to the user portable terminal 7, from the temporary storage 1118 or the history DB 1106, and attaches the latest content information to the mail created in the step S608 (S609). Thus, the mail transmitter 1116 forms an extracting part for extracting the content information from the temporary storage 1118 or the history DB 1106 according to user information (regarding the user portable terminal 7 having received the content information) and the transmission request selection information regarding the content information. In this course, depending on the capability of the user portable terminal, the content information may be transmitted with only texts or with images. Further, not the content information as it is, but an extraction of texts and images from the content information may be transmitted.

The mail transmitter 1116 controls the communication controller 1101 to transmit the mail created as above to the mail address extracted in the step S605 (S610). Thus, the mail transmitter 1116 forms a mail transmitting part for transmitting the mail including the content information to a terminal of the mail address corresponding to the user ID using the user portable terminal 7. The mail manager 705 receives this mail via the wireless communicator 701 (S611), and the mail manager 705 stores the received mail in the mail storage 706 (S612).

When the user selects a “content information” mark displayed in the mail as read in the screen 2001 shown in FIG. 27 so as to browse the same content information again, the content information attached to the mail stored in the mail storage 706 is browsed. Accordingly, the user can browse the desired content information without using the communication networks or the content relay server 11. Therefore, the user does not have to pay the toll for using the communication networks, and the load of the content relay server 11 becomes light.

In addition, the user can connect to the same content providing server by specifying a mail address of the content providing server written in the mail without remembering the mail address.

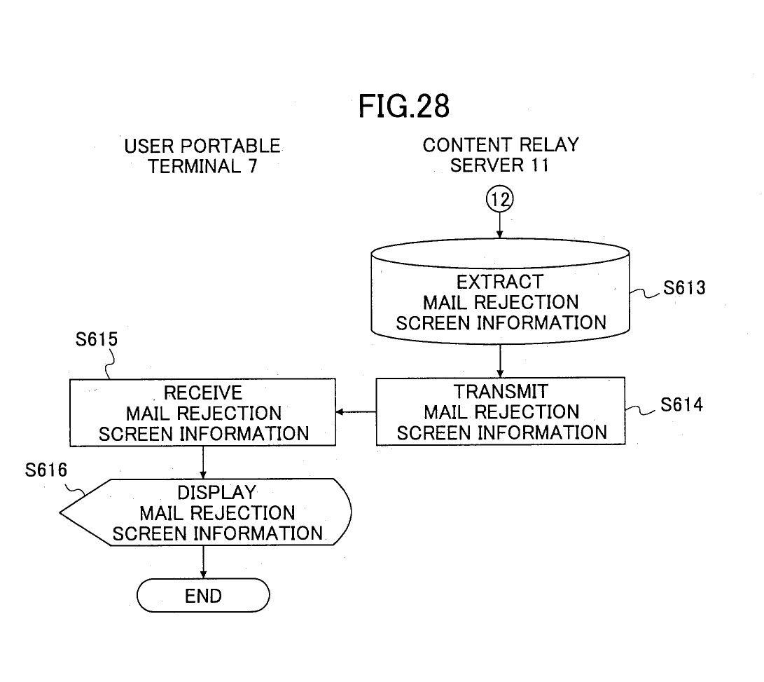

In the foregoing step S604, when the mail transmitter 1116 judges that the user portable terminal 7 is not authenticated (N in S604), a procedure is preformed according to a flowchart shown in FIG. 28.

Specifically, the mail transmitter 1116 extracts screen information indicating a rejection of mail transmission from the screen information storage 1119 (S613), and controls the communication controller 1101 to transmit this screen information to the user portable terminal 7 (S614). When the Internet browser 702 receives this screen information via the wireless communicator 701 (S615), the Internet browser 702 displays the screen information indicating the rejection of mail transmission on the display 704 (S616), and ends the procedure.

Thus, when the user portable terminal 7 is not authenticated, the mail transmission is not performed so as to distinguish a user with an authenticated user ID from a user without an authenticated user ID.

Besides, upon registering the user ID, the user register 1102 may store information indicating whether or not a file can be attached to a mail transmitted to the user terminal 5 or the user portable terminal 7. By referring to this information, the mail transmitter 1116 may attach or not attach the content information in the foregoing step S609. Accordingly, the content information can be provided for the user in a form corresponding to the type of the terminal used by the user.

The present invention is not limited to the specifically disclosed embodiments, and variations and modifications may be made without departing from the scope of the present invention.

The present application is based on Japanese priority application No. 2002-246634 filed on Aug. 27, 2002, the entire contents of which are hereby incorporated by reference.

What is claimed is:

1. A content relay method performed by a content relay device including a history storage for storing history information upon relaying content information between a content providing server and a terminal, and a communicating part for communicating with a network, the content relay device obtaining the content information from said content providing server via said network, and relaying said content information to said terminal, the method comprising:
a user information obtaining step of obtaining user identification information from said terminal;
a content information obtaining step of obtaining the content information from said content providing server;
a history storing step of storing the history information regarding said content information in said history storage upon relaying said content information between said content providing server and said terminal, the history information being related to said user identification information;
an extracting step of extracting entry history information from said history storage according to said user identification information and information regarding content information obtained by said content information obtaining step when said content information includes information requesting an entry of information; and
a transmitting step of transmitting said entry history information extracted by said extracting step to said terminal.

2. The content relay method as claimed in claim 1, wherein said transmitting step includes creating content information for displaying said entry history information extracted by said extracting step and said content information obtained by said content information obtaining step on a same screen, and transmitting the created content information to said terminal.

3. The content relay method as claimed in claim 2, wherein said content relay device includes a language translation rule storage for storing a language translation rule, and
said transmitting step includes creating content information for displaying said entry history information extracted by said extracting step and the content information obtained by said content information obtaining step and translated by referring to said language translation rule storage into a language used by said terminal on a same screen, and transmitting the created content information to said terminal.

4. A content relay method performed by a content relay device including a history storage for storing history information upon relaying content information between a content providing server and a terminal, and a communicating part for communicating with a network, the content relay device obtaining the content information from said content providing server via said network, and relaying said content information to said terminal, the method comprising:
a user information obtaining step of obtaining user identification information from said terminal;
a content information obtaining step of obtaining the content information from said content providing server;
a history storing step of storing the history information regarding said content information in said history storage upon relaying said content information between said content providing server and said terminal, the history information being related to said user identification information;
a transmitting step of transmitting said content information obtained by said content information obtaining step to said terminal;
an extracting step of extracting said content information from said history storage according to said user identification information and information regarding said content information upon receiving a request from said terminal for transmitting said content information thereto after said transmitting step; and
a mail transmitting step of transmitting said content information extracted by said extracting step to said terminal by electronic mail.

5. The content relay method as claimed in claim 4, wherein said content relay device includes a language translation rule storage for storing a language translation rule, and
said transmitting step includes translating said content information obtained by said content information obtaining step into a language used by said terminal by referring to said language translation rule storage, and transmitting the translated content information to said terminal.

6. A content relay device capable of communicating with a network so as to relay content information obtained from a content providing server via said network to a terminal, the device comprising:
a user information obtaining part for obtaining user identification information from said terminal;
a content information obtaining part for obtaining the content information from said content providing server;
a history storage for storing history information upon relaying said content information between said content providing server and said terminal;
a history storage controller for storing said history information regarding said content information in said history storage upon relaying said content information between said content providing server and said terminal, the history information being related to said user identification information;
an extracting part for extracting entry history information from said history storage according to said user identification information and information regarding content information obtained by said content information obtaining part when said content information includes information requesting an entry of information; and
a transmitting part for transmitting said entry history information extracted by said extracting part to said terminal.

7. The content relay device as claimed in claim 6, wherein said transmitting part creates content information for displaying said entry history information extracted by said extracting part and said content information obtained by said content information obtaining part on a same screen, and transmits the created content information to said terminal.

8. The content relay device as claimed in claim 7, further comprising a language translation rule storage for storing a language translation rule, and
said transmitting part creates content information for displaying said entry history information extracted by said extracting part and the content information obtained by said content information obtaining part and translated by referring to said language translation rule storage into a language used by said terminal on a same screen, and transmits the created content information to said terminal.

9. A content relay device comprising:
a communicating part for communicating with a network so as to obtain content information from a content providing server via said network, and relay said content information to a terminal;
a user information obtaining part for obtaining user identification information from said terminal;
a content information obtaining part for obtaining said content information from said content providing server;
a history storage for storing history information upon relaying said content information between said content providing server and said terminal;
a history storage controller for storing said history information regarding said content information in said history storage upon relaying said content information between said content providing server and said terminal, the history information being related to said user identification information;
a transmitting part for transmitting said content information obtained by said content information obtaining part to said terminal;
an extracting part for extracting said content information from said history storage according to said user identification information and information regarding said content information upon receiving a request from said terminal for transmitting said content information thereto after said transmitting part transmits said content information obtained by said content information obtaining part to said terminal; and
a mail transmitting part for transmitting said content information extracted by said extracting part to said terminal by electronic mail.

10. The content relay device as claimed in claim 9, further comprising a language translation rule storage for storing a language translation rule, and
said transmitting part translates said content information obtained by said content information obtaining part into a language used by said terminal by referring to said language translation rule storage, and transmits the translated content information to said terminal.

11. A content relay program for causing a computer comprising a function of communicating with a network to function as:
a user information obtaining part for obtaining user identification information from a terminal;
a content information obtaining part for obtaining content information from a content providing server;
a history storage for storing history information upon relaying said content information between said content providing server and said terminal;
a history storage controller for storing said history information regarding said content information in said history storage upon relaying said content information between said content providing server and said terminal, the history information being related to said user identification information;
an extracting part for extracting entry history information from said history storage according to said user identification information and information regarding content information obtained by said content information obtaining part when said content information includes information requesting an entry of information; and
a transmitting part for transmitting said entry history information extracted by said extracting part to said terminal.

12. A computer readable recording medium storing program code for causing a computer comprising a function of communicating with a network to obtain content information from a content providing server via said network, and to relay said content information to a terminal, the recording medium comprising:
user information obtaining program code means for obtaining user identification information from said terminal;
content information obtaining program code means for obtaining the content information from said content providing server;
history storage controlling program code means for storing history information regarding said content information in history storage upon relaying said content information between said content providing server and said terminal, the history information being related to said user identification information;
extracting program code means for extracting entry history information from said history storage according to said user identification information and information regarding content information obtained by said content information obtaining program code means when said content information includes information requesting an entry of information; and
transmitting program code means for transmitting said entry history information extracted by said extracting program code means to said terminal.
